(19) United States
(12) Patent Application Publication
(10) Pub. No.: US 2023/0039058 A1
(43) Pub. Date: Feb. 9, 2023

(54) Sm-Fe-N MAGNET

(71) Applicants: Hirotaka YOKOTA, Tokyo (JP); Eiichiro Fukuchi, Tokyo (JP); Shusuke Okada, Aichi (JP); Kenta Takagi, Aichi (JP)

(72) Inventors: Hirotaka YOKOTA, Tokyo (JP); Eiichiro Fukuchi, Tokyo (JP); Shusuke Okada, Aichi (JP); Kenta Takagi, Aichi (JP)

(73) Assignees: TDK Corporation, Tokyo (JP); National Institute of Advanced Industrial Science and Technology, Tokyo (JP)

(21) Appl. No.: 17/815,342

(22) Filed: Jul. 27, 2022

(30) Foreign Application Priority Data
Jul. 29, 2021 (JP) 2021-124120

(51) Int. Cl. H01F 1/059; B22F 1/05; B22F 1/17; C22C 38/00

(52) U.S. Cl. CPC H01F 1/059; B22F 1/05; B22F 1/17; C22C 38/005; C22C 38/001; B22F 2301/355

(57) ABSTRACT

A Sm—Fe—N magnet includes Sm—Fe—N particles, wherein an inter-particle metal phase is present between at least two of the Sm—Fe—N particles, an average particle diameter of the Sm—Fe—N particles is less than 2.0 μm, and a percentage of the Sm—Fe—N particles having an aspect ratio of 2.0 or more is 10% or less, the inter-particle metal phase includes a Fe₃Zn₁₀ phase and an α-Fe phase in a particle form, and in the inter-particle metal phase, an area ratio of the Fe₃Zn₁₀ phase is 80% or more.

### CROSS-REFERENCE TO RELATED APPLICATIONS

The present application is based on and claims priority to Japanese Priority Application No. 2021-124120 filed on Jul. 29, 2021, the entire contents of which are hereby incorporated herein by reference.

### BACKGROUND

### Technical Field

The present disclosure relates to a Sm—Fe—N magnet.

### Description of Related Art

The Sm—Fe—N magnet is expected to be a high-performance magnet because of its high Curie temperature of 477 degrees Celsius, its small temperature variation in magnetic properties, and its high anisotropic magnetic field of 20.6 MA/m, which is the theoretical limit of coercivity.

International Publication No. 2017/150557 discloses a method for producing a fine Sm—Fe—N powder including a reduction-diffusion process of a precursor powder to produce an alloy powder and a nitriding process.

In order to manufacture a high-performance magnet from a magnetic powder having a high coercivity, it is necessary to sinter the Sm—Fe—N powder.

However, when the Sm—Fe—N powder is sintered at a high temperature, there is a problem in that the magnetic properties deteriorate. In particular, the coercivity of the Sm—Fe—N magnet gets greatly reduced by the sintering process.

Furthermore, International Publication No. 2019/189440 proposes that the surface of the Sm—Fe—N powder is coated with a sub-phase containing a metal such as zirconium, which alleviate a reduction in the coercivity of the magnet obtained by sintering.

### SUMMARY

Generally, a Sm—Fe—N magnet are produced by sintering Sm—Fe—N powder under a pressurized condition. However, when the Sm—Fe—N magnet is sintered under a pressurized condition, the coercivity of the magnet is greatly reduced as compared with the coercivity of the powder, and there is a problem in that it is difficult to obtain a Sm—Fe—N magnet having both high density and coercivity.

In view of such background, it is desired to provide a Sm—Fe—N magnet that has a high density and that significantly alleviates a reduction in the coercivity as compared with the coercivity of Sm—Fe—N powder.

The present disclosure provides:

a Sm—Fe—N magnet including:

Sm—Fe—N particles,

wherein an inter-particle metal phase is present between at least two of the Sm—Fe—N particles,

an average particle diameter of the Sm—Fe—N particles is less than 2.0 μm, and a percentage of the Sm—Fe—N particles having an aspect ratio of 2.0 or more is 10% or less,

the inter-particle metal phase includes a Fe₃Zn₁₀ phase and an α-Fe phase in a particle form, and

in the inter-particle metal phase, an area ratio of the Fe3Zn10 phase is 80% or more.

### BRIEF DESCRIPTION OF THE DRAWINGS

FIG. 1 is a drawing schematically illustrating an example of configuration of a cross section of a Sm—Fe—N magnet according to an embodiment of the present disclosure.

FIG. 2 is a drawing schematically illustrating an example of a flow of a method for producing the Sm—Fe—N magnet according to the embodiment of the present disclosure.

FIG. 3 is a drawing schematically illustrating an example of a flow of a method for producing Sm—Fe—N magnet powder in the method for producing the Sm—Fe—N magnet according to the embodiment of the present disclosure.

FIG. 4 is an EDS (Energy Dispersive X-ray Spectrometry) mapping image of Zn, Fe, and Sm in a cross section of the Sm—Fe—N magnet according to the embodiment of the present disclosure.

FIG. 5 is an electron diffraction image of an inter-particle metal phase in a cross section of the Sm—Fe—N magnet according to the embodiment of the present disclosure.

FIG. 6 is a cross-sectional TEM (Transmission Electron Microscopy) image of the Sm—Fe—N magnet according to the embodiment of the present disclosure, showing analysis portions (a mark “*1” and a mark “*2”) of FIG. 5.

FIG. 7 is an EDS mapping image of Zn in an area indicated in FIG. 6.

### DETAILED DESCRIPTION

Hereinafter, an embodiment of the present disclosure is explained.

As described above, it is known that, when the Sm—Fe—N magnet is sintered under a pressurized condition, the coercivity of the magnet gets greatly reduced as compared with the coercivity of the powder.

Therefore, the Sm—Fe—N magnet needs to be sintered from Sm—Fe—N powder under a non-pressurized condition. However, it is difficult to obtain a Sm—Fe—N magnet of a sufficient density by such a production method.

In contrast, according to the embodiment of the present disclosure, as explained in detail below, a Sm—Fe—N magnet that has a high density and that significantly alleviates a reduction in the coercivity as compared with the coercivity of Sm—Fe—N powder can be provided.

An embodiment of the present disclosure provides a Sm—Fe—N magnet including:

Sm—Fe—N particles,

wherein an inter-particle metal phase is present between at least two of the Sm—Fe—N particles,

an average particle diameter of the Sm—Fe—N particles is less than 2.0 μm, and a percentage of the Sm—Fe—N particles having an aspect ratio of 2.0 or more is 10% or less,

the inter-particle metal phase includes a Fe₃Zn₁₀ phase and an α-Fe phase in a particle form, and

in the inter-particle metal phase, an area ratio of the Fe₃Zn₁₀ phase is 80% or more.

In the present application, the area ratio of each phase in the inter-particle metal phase is an average value obtained by image analysis of a cross-sectional photo. Specifically, Sm—Fe—N particles, inter-particle metal phases, oxidation phases, voids, and the like are identified by FE-SEM (Field Emission Scanning Electron Microscopy) backscattered electron image or by EDS mapping of a cross section of an exposed sample, and an area ratio of a target phase is derived by image analysis. The area ratio is determined by averaging area ratios derived from 20 cross-sectional photos, the field of view of each of which includes 20 or more Sm—Fe—N particles.

In the Sm—Fe—N magnet according to the embodiment of the present disclosure, an inter-particle metal phase is provided between at least two of the Sm—Fe—N particles. This inter-particle metal phase includes: a Fe₃Zn₁₀ phase, of which the area ratio is 80% or more; and an α-Fe phase in a particle form.

Generally, in the case where the α-Fe in the particle form is present on the surfaces of the Sm—Fe—N particles, and when a magnetic field is applied to the Sm—Fe—N particles, the α-Fe causes a reversal of the magnetization of the Sm—Fe—N particles, and the coercivity of the magnet decreases.

However, in the embodiment of the present disclosure, the α-Fe phase in the particle form is provided in the inter-particle metal phase, not on the surface of the Sm—Fe—N particle. Specifically, the α-Fe phase in the particle form is not directly in contact with the Sm—Fe—N particle, but is bin contact with the Sm—Fe—N particle via the Fe₃Zn₁₀ phase occupying the majority of the inter-particle metal phase.

In such a state, a reversal of the magnetization due to the α-Fe phase is less likely to occur. Accordingly, even in a case where the magnet is produced by pressure-sintering the Sm—Fe—N particles, a reduction in the coercivity can be significantly alleviated.

Furthermore, the Sm—Fe—N magnet according to the embodiment of the present disclosure can be produced by performing a pressure-sintering process on the Sm—Fe—N particles. Therefore, according to the embodiment of the present disclosure, the Sm—Fe—N magnet that has a sufficiently high density can be produced.

(Sm—Fe—N Magnet According to the Embodiment of the Present Disclosure)

Hereinafter, the embodiment of the present disclosure is explained in detail with reference to drawings.

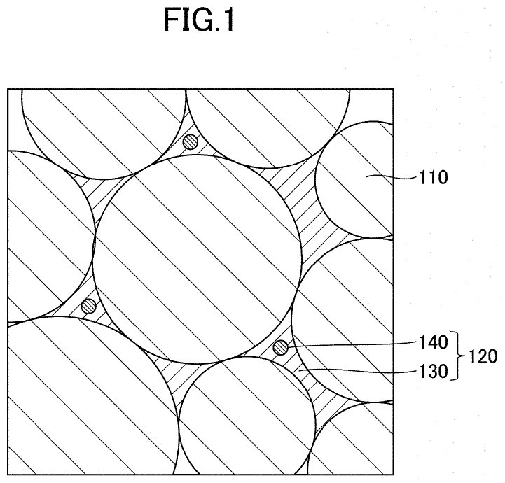

FIG. 1 schematically illustrates an example of a cross section of a portion of a Sm—Fe—N magnet 100 according to the embodiment of the present disclosure (hereinafter referred to as a “first magnet”).

The first magnet 100 includes multiple Sm—Fe—N particles 110 connected with each other, as illustrated in FIG. 1.

Furthermore, the first magnet 100 includes an inter-particle metal phase 120 formed between at least two of the Sm—Fe—N particles 110.

The inter-particle metal phase 120 mainly includes: an Fe₃Zn₁₀ phase 130; and an α-Fe phase 140 in a particle form that is present in the Fe₃Zn₁₀ phase 130.

In the inter-particle metal phase 120, the ratio (the area ratio) of the Fe₃Zn₁₀ phase 130 is 80% or more. In the inter-particle metal phase 120, the area ratio of the α-Fe phase 140 in the particle form is, for example, 10% or less.

In the inter-particle metal phase 120, the α-Fe phase 140 in the particle form is covered with the Fe₃Zn₁₀ phase 130. Therefore, because of the effects explained above, in the first magnet 100, the inter-particle metal phase 120 is provided between at least two of the Sm—Fe—N particles 110, so that a reduction in the coercivity can be significantly alleviated.

Furthermore, the first magnet 100 having the configuration as explained above can be produced by performing a pressure-sintering process on the Sm—Fe—N powder. Therefore, the first magnet 100 has a sufficiently high density.

For example, the first magnet 100 may have a residual magnetic flux density of 4.8 kG or more.

(Details of Each Portion of Sm—Fe—N Magnet According to the Embodiment of the Present Disclosure)

Next, each portion of the Sm—Fe—N magnet according to the embodiment of the present disclosure is explained in more detail.

Hereinafter, each portion included in the Sm—Fe—N magnet according to the embodiment of the present disclosure is explained using the first magnet 100 explained above as an example. Accordingly, respective portions of the Sm—Fe—N magnet are denoted with reference numerals in FIG. 1.

(Sm—Fe—N Particle 110)

The Sm—Fe—N particle 110 is a particle containing Sm (samarium), Fe (iron), and N (nitrogen).

The Sm—Fe—N particle 110 may contain other additional elements. The additional element may be at least one selected from the group consisting of: for example, rare earth elements such as neodymium and praseodymium (excluding samarium); and cobalt.

The total content of the additional elements is preferably less than 30 at % in terms of the anisotropic magnetic field and magnetization.

The average particle diameter of the Sm—Fe—N particles 110 is preferably less than 2.0 μm. When the average particle diameter of the Sm—Fe—N particles 110 is less than 2.0 μm, the coercivity of the Sm—Fe—N magnet is further increased.

In the magnet according to the embodiment of the present disclosure, the ratio of Sm—Fe—N particles 110 having an aspect ratio of 2.0 or more is preferably 10% or less, more preferably 8% or less. When the ratio of Sm—Fe—N particles 110 having an aspect ratio of 2.0 or more is 10% or less, the coercivity of the magnet according to the embodiment of the present disclosure is further increased. Furthermore, the average particle diameter of the Sm—Fe—N particles 110 is preferably larger than 0.1 μm. When the average particle diameter of the Sm—Fe—N particles 110 is 0.1 μm or less, it is difficult to alleviate oxidation of the Sm—Fe—N particles, and a different phase is likely to occur in the magnet according to the embodiment of the present disclosure.

The Sm—Fe—N particles 110 include oxygen at, for example, less than 1 wt %. When the Sm—Fe—N particles 110 include oxygen at a higher ratio, the magnet according to the embodiment of the present disclosure is more likely to have a different phase.

(Inter-Particle Metal Phase 120)

As described above, the area ratio of the Fe₃Zn₁₀ phase 130 included in the inter-particle metal phase 120 is 80% or more. The area ratio of the Fe₃Zn₁₀ phase 130 is preferably 82% or more.

The area ratio of the α-Fe phase 140 in the particle form included in the inter-particle metal phase 120 is, for example, 10% or less, and is preferably 5% or less.

The average particle diameter of the α-Fe phase 140 is, for example, in a range of 5 nm or more and 500 nm or less, and is preferably in a range of 30 nm or more and 300 nm or less.

In the present application, the average particle diameter of the α-Fe phase 140 in the particle form means an average of measured values of 30 particles.

The inter-particle metal phase 120 is a phase of which the content of rare earth elements and metal elements such as iron (Fe), zinc (Zn) excluding oxygen, carbon, nitrogen, and the like is 80 at % or more. In addition, the first magnet 100 may include not only the Sm—Fe—N particle 110 and the inter-particle metal phase 120 but also other phases such as oxides, nitrides and/or carbides.

(Other Features)

In the Sm—Fe—N magnet according to the embodiment of the present disclosure, a coating layer may be formed in at least a portion of the surface of the Sm—Fe—N particle 110.

The coating layer is mainly constituted by a Sm—Fe—Zn phase. The coating layer includes Zn, for example, at 1 at % or more and 20 at % or less, and preferably at 5 at % or more and 15 at % or less.

Furthermore, the coating layer may have a thickness of, for example, 1 nm or more and 100 nm or less, and preferably has a thickness of 20 nm or more and 50 nm or less. In the present application, “the thickness of the coating layer” means an average of measured values obtained from 20 Sm—Fe—N particles 110.

The coating layer does not have to be provided on the entirety of the surface of the Sm—Fe—N particle 110. Specifically, the coating layer may be provided intermittently or locally in a portion of the surface of the Sm—Fe—N particle 110.

The amount of Zn included in the Sm—Fe—N magnet according to the embodiment of the present disclosure is, for example, in a range of 1 wt % to 20 wt %.

Furthermore, the amount of oxygen included in the Sm—Fe—N magnet according to the embodiment of the present disclosure is, for example, less than 1 wt %, and is preferably less than 0.8 wt %.

(Method for Producing Sm—Fe—N Magnet According to the Embodiment of the Present Disclosure)

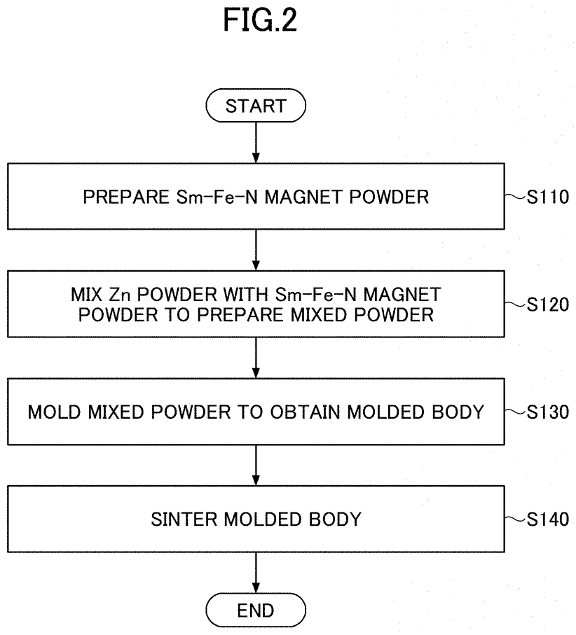

Next, a method for producing the Sm—Fe—N magnet according to the embodiment of the present disclosure is explained in more detail with reference to FIG. 2.

FIG. 2 schematically illustrates an example of a flow of a method for producing a Sm—Fe—N magnet (hereinafter referred to as a “first method”) according to the embodiment of the present disclosure.

As illustrated in FIG. 2, the first method includes:

preparing Sm—Fe—N magnet powder (step S110);

mixing Zn powder with the Sm—Fe—N magnet powder to prepare mixed powder (step S120);

molding the mixed powder to obtain a molded body (step S130); and

pressure-sintering the molded body (step S140).

Hereinafter, each step is explained.

(Step S110)

First, Sm—Fe—N magnet powder is prepared.

The method for producing the magnet powder is not particularly limited.

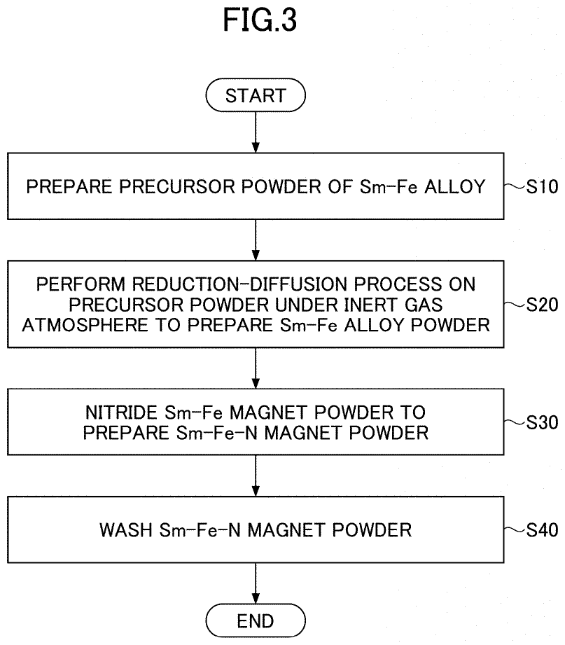

Hereinafter, an example of the method for producing the magnet powder is explained with reference to FIG. 3.

FIG. 3 schematically illustrates a flow of a method for producing Sm—Fe—N magnet powder.

As illustrated in FIG. 3, a method for producing the magnet powder includes:

preparing precursor powder of a samarium-iron (Sm—Fe) alloy (S10);

performing a reduction-diffusion process on the precursor powder under an inert gas atmosphere to prepare Sm—Fe alloy powder (S20);

nitriding the Sm—Fe magnet powder to prepare Sm—Fe—N magnet powder (S30); and

washing the Sm—Fe—N magnet powder (S40).

Hereinafter, each step is briefly explained.

(Step S10)

First, a precursor powder of Sm—Fe alloy is prepared.

The precursor powder may be, for example, Sm—Fe oxide powder or Sm—Fe hydroxide powder. Hereinafter, the Sm—Fe oxide powder and the Sm—Fe hydroxide powder are collectively referred to as Sm—Fe hydrooxide powder.

The precursor powder may be prepared, for example, by a coprecipitation method. In this method, a precipitating agent such as an alkali is first added to a solution containing a samarium salt or an iron salt to cause precipitation, and then the precipitate is recovered by filtration, centrifugation, and the like. Then, the precipitate is washed and dried, and the precipitate is pulverized to obtain Sm—Fe hydrooxide powder.

When the Sm—Fe—N magnet powder contains metallic iron, the magnetic characteristic decreases. Therefore, when the precursor powder is produced, it is preferable to add samarium at an amount larger than the stoichiometric ratio.

The counter ion in the samarium salt and the iron salt may be an inorganic ion such as a chloride ion, a sulfate ion, a nitrate ion, or an organic ion such as an alkoxide.

Water may be used as the solvent contained in the solution containing the samarium salt and the iron salt, but an organic solvent such as ethanol may be used.

As the alkali, hydroxides of alkali metal and alkaline earth metal and ammonia can be used. A compound which decomposes by external action such as heat and acts as a precipitating agent, such as urea, may be used.

The obtained precursor powder may then be handled in an atmosphere shielded environment, such as a glovebox, until Sm—Fe—N magnet powder is produced. When an inert gas atmosphere is used, the oxygen concentration is preferably 1 ppm or less.

The obtained precursor powder is preferably pre-reduced in a reducing atmosphere. Thus, the amount of calcium used in a subsequent reduction-diffusion process step (step S20) decreases, and the generation of coarse Sm—Fe alloy particles can be alleviated.

The pre-reduction of the precursor powder may be performed, for example, by heating the precursor powder to 400° C. or higher in a hydrogen atmosphere. The treatment temperature is preferably in a range of 500° C. to 800° C. When the pre-reduction is performed in this temperature range, powder of Sm—Fe alloy with uniform particle diameter can be obtained.

(Step S20)

Next, the reduction-diffusion treatment is performed on the precursor powder in an inert gas atmosphere.

Examples of methods for performing the reduction-diffusion process include a method in which the precursor powder is mixed with calcium (Ca) or calcium hydride (CaH₂) and then heated to a temperature equal to or higher than the melting point of Ca (about 842° C.)

During this treatment, Sm reduced by Ca diffuses through the Ca melt and reacts with Fe to form Sm—Fe alloy powder.

There is a correlation between the temperature of the reduction-diffusion process and the particle diameter of the Sm—Fe alloy powder, and as the reduction-diffusion temperature increases, the particle diameter of the Sm—Fe alloy powder increases.

The average particle diameter of the Sm—Fe alloy powder is preferably less than 2.0 μm. When the average particle diameter of the Sm—Fe alloy powder is less than 2.0 μm, the coercivity of the magnet is further increased. Furthermore, the average particle diameter of the Sm—Fe alloy powder is preferably more than 0.1 μm and less than 2.0 μm.

In order to obtain Sm—Fe alloy powder having a uniform particle diameter, the reduction-diffusion treatment is performed on the precursor powder at 850° C. to 1050° C. for about 1 minute to 2 hours under an inert gas atmosphere.

With the progress of the reduction-diffusion process in the precursor, crystallization occurs to form Sm—Fe alloy powder. In addition, in the obtained Sm—Fe alloy powder, a Sm-rich phase is formed in at least a portion of the surface of each particle.

In the Sm—Fe alloy powder, the ratio of the number of particles having an aspect ratio of 2.0 or more is preferably 10% or less, and is more preferably 8% or less. When the ratio of the particles having an aspect ratio of 2.0 or more is 10% or less, the coercivity of the magnet powder is further increased.

The amount of residual oxygen in the Sm—Fe alloy powder obtained after step S20 is preferably less than 1.0 wt %. When the amount of residual oxygen of the Sm—Fe alloy powder is less than 1.0 wt %, the coercivity of the magnet is further increased.

(Step S30)

Next, the nitriding process is performed on the obtained Sm—Fe alloy powder.

Examples of methods for nitriding the Sm—Fe alloy powder include a method for heat-treating the Sm—Fe alloy powder at 300° C. to 500° C. in an atmosphere such as ammonia, a mixed gas of ammonia and hydrogen, nitrogen, or a mixed gas of nitrogen and hydrogen.

When ammonia is used, the Sm—Fe alloy powder can be nitrided in a short time. However, the amount of nitrogen in the Sm—Fe—N magnet powder may be higher than the optimum value. In this case, the Sm—Fe alloy powder is preferably nitrided and then annealed in hydrogen. Thus, excess nitrogen can be discharged from the crystal lattice.

The Sm—Fe—N magnet powder is famed by a nitriding process.

The composition of the particles contained in the Sm—Fe—N magnet powder is preferably Sm₂Fe₁₇N₃.

For example, the Sm—Fe alloy powder is heat-treated at 350° C. to 450° C. for 10 minutes to 2 hours under an ammonia-hydrogen mixed atmosphere, and then annealed at 350° C. to 450° C. for 30 minutes to 2 hours under a hydrogen atmosphere. Thus, the amount of nitrogen in the Sm—Fe—N magnet powder can be optimized.

(Step S40)

Next, the Sm—Fe—N magnet powder formed in step S30 is washed.

The Sm—Fe—N magnet powder formed in step S30 contains a calcium compound. A washing treatment is performed to remove the calcium compound.

The washing treatment is performed using, for example, a washing liquid such as water or alcohol, or both. Alternatively, the washing solution may be an acid such as amidosulfuric acid. Alternatively, the Sm—Fe—N magnet powder may be washed with water or alcohol, or both, and then washed with amide sulfuric acid. The temperature of the washing liquid is not particularly limited, but it is preferable to select a temperature at which the solubility of CaO and Ca(OH)₂ is high. For example, in a case where the washing liquid is water, the washing liquid is preferably at 0° C. to room temperature.

The washing step may be performed before the nitriding treatment.

The washed Sm—Fe—N magnet powder is preferably dried thereafter.

The drying temperature is not particularly limited, but the drying temperature is preferably room temperature to 100° C. The oxidation of the Sm—Fe—N magnet powder can be alleviated by setting the drying temperature to 100° C. or less.

Furthermore, a dehydrogenation process may be performed on the Sm—Fe—N magnet powder. Hydrogen that has entered the crystal lattice during the washing treatment can be removed by the dehydrogenation process.

The method of the dehydrogenation process is not particularly limited. For example, dehydrogenation may be performed by heating the Sm—Fe—N magnet powder under vacuum or in an inert gas atmosphere. For example, a dehydrogenation process may be performed on the Sm—Fe—N magnet powder through the heat treatment at 150° C. to 250° C. for 1 hour in a vacuum atmosphere.

According to the above steps, the Sm—Fe—N magnet powder can be produced. The amount of residual oxygen in the magnet powder is less than 1.0 wt %.

The average particle diameter of the obtained Sm—Fe—N magnet powder is preferably more than 0.1 μm and less than 2.0 μm.

The amount of residual oxygen is preferably 1.0 wt % or less, and is more preferably less than 0.8 wt %.

(Step S120)

Next, Zn powder is mixed with the Sm—Fe—N magnet powder produced by the above-described method to prepare mixed powder.

The average particle diameter of the Zn powder is in a range of, for example, 5 μm to 100 μm. In particular, the average particle diameter of the Zn powder is preferably larger than that of the Sm—Fe—N magnet powder.

The mixing amount of the Zn powder is not particularly limited, but may be, for example, 1 wt % or more and 20 wt % or less with respect to the entirety of the mixed powder.

Although the method of mixing the Sm—Fe—N magnet powder and the Zn powder is not particularly limited, it is preferable to mix the Sm—Fe—N magnet powder so as not to cause physical damage to the surface of each particle of the Sm—Fe—N magnet powder. For example, it is preferable to avoid methods such as mixing by a ball-mill and crushing.

(Step S130)

Next, the mixed powder is molded to produce a molded body.

The molding is preferably performed under an environment where a magnetic field, such as a static magnetic field, is applied. When molding is performed under the static magnetic field, a molded body in which the easy axis of magnetization of magnet particles is oriented along the static magnetic field can be obtained, and an anisotropic magnet can be obtained after sintering.

For example, a molded body is obtained by pressurizing the mixed powder with a mold while applying a static magnetic field to the mixed powder in the mold.

The pressure applied by the mold to the mixed powder may be, for example, 10 MPa or more and 3000 MPa or less. In order to uniformly diffuse Zn, the pressure is preferably 500 MPa or less.

The strength of the magnetic field applied to the mixed powder may be 400 kA/m or more and 3000 kA/m or less.

(Step S140)

Next, the sintering process is performed on the molded body in a pressurized condition.

The Zn particles contained in the molded body is dissolved by the sintering process. The dissolved Zn is spread to cover the Sm—Fe—N magnet powder during the sintering process, and eventually the magnet in the form as described above can be formed.

The sintering process in the pressurized condition may be performed, for example, by a spark plasma sintering method, a hot press method, or a electric-current pressure sintering. Among these, the electric-current pressure sintering which can achieve low heat load sintering by high-speed heating and short-time sintering is preferable.

The sintering conditions may be appropriately set in accordance with the composition of the magnet to be produced and the average particle diameter of the powder contained therein.

The sintering process may include a temperature raising process and a temperature holding process subsequent to the temperature raising process, or may include only the temperature raising process.

The reaching temperature in the temperature raising process may be, for example, 420° C. or more and 600° C. or less.

The heating rate in the heating process may be, for example, 5° C./min or more and 100° C./min or less.

The sintering time in the temperature holding process may be, for example, 5 hours or less, and may be 0 hours.

The method of heating the molded article is not particularly limited. The molded body may be sintered by resistance heating, electrical heating, or radio frequency heating.

For example, the molded body may be pressurized while the molded body is put in a mold.

The applied pressure is, for example, in a range of 1 GPa to 2 GPa, and preferably in a range of 1.2 GPa to 1.5 GPa.

The application of pressure may be started from room temperature. Alternatively, the application of the pressure may be started after the temperature of the molded body reaches around the melting point of Zn (for example, around 420° C.)

The atmosphere of the sintering process is, for example, a nitrogen atmosphere, an argon atmosphere, or a vacuum (reduced pressure atmosphere). The oxygen concentration and the water concentration in the atmosphere are preferably 1 ppm or less, and preferably 0.5 ppm or less, respectively. These concentrations are in mole fractions.

The sintered body may be cooled after the sintering process. The cooling rate of the sintered body may be, for example, 5° C./min or more and 100° C./min or less.

The Sm—Fe—N magnet having the above-described characteristics can be produced by the above process.

### EXAMPLES

Hereinafter, examples of the present disclosure is explained. In the following explanation, Examples 1 to 4 are examples of the present embodiment and Examples 11 to 12 are comparative examples.

### Example 1

The Sm—Fe—N magnet was produced according to the following method.

(Preparation of Mixed Powder)

First, mixed powder was prepared according to the following method.

(Preparation of Sm—Fe-Hydrooxide Powder)

After 64.64 g of iron nitrate enneahydrate and 12.93 g of samarium nitrate hexahydrate were dissolved in 800 ml of water, 120 ml of a potassium hydroxide aqueous solution at a concentration of 2 mol/L was added dropwise while stirring, and the mixture was stirred overnight at room temperature to prepare a suspension. The suspension was then filtered, the filtrate was washed, and thereafter, dried overnight at 120° C. in an air atmosphere using a hot air oven. Next, the filtrate was coarsely ground by a blade mill and then finely ground in ethanol by a rotary mill using a stainless steel ball. Then, the filtrate pulverized in ethanol was centrifuged and dried in vacuum to prepare Sm—Fe-hydrooxide powder.

(Pre-Reduction)

Sm—Fe-hydrooxide powder was pre-reduced by a heat process at 600° C. for 6 hours under a hydrogen atmosphere to prepare powder (referred to as powder A).

(Reduction-Diffusion Process)

5.0 g of powder A and 2.5 g of calcium powder were put into an iron crucible, and the mixture was heated and kept at 900° C. for 1 hour to perform a reduction-diffusion process to prepare powder (referred to as powder B).

(Nitriding)

After the powder B was cooled to normal temperature, the temperature was raised to 380° C. under a hydrogen atmosphere. Next, the powder B was nitrided by raising the temperature to and kept at 420° C. for 1 hour in an ammonia-hydrogen mixed atmosphere with a volume ratio of 1:2.

Next, after the powder B was annealed at 420° C. for 1 hour under a hydrogen atmosphere, the powder B is annealed at 420° C. for 0.5 hours under an argon atmosphere to optimize the amount of nitrogen in the powder B. Thus, powder C was obtained.

(Washing)

The powder C was washed five times with pure water. The powder C having been washed and an aqueous solution of amide sulfuric acid were added and kept at pH 5 for 15 minutes to remove the calcium compound. Next, the powder C was washed with pure water to remove the amidosulfuric acid. Thus, powder D was obtained.

(Vacuum Drying)

The water remaining in the powder D was replaced with 2-propanol, and then dried in vacuum at room temperature.

The powder D having been dried in vacuum was dehydrated at 200° C. for 3 hours under vacuum.

The steps of the pre-reduction and subsequent steps were performed in the glovebox in an argon atmosphere without being exposed to the atmosphere.

The Sm—Fe—N magnet powder (hereinafter referred to as “powder E”) was obtained as a result of performing the above-described steps.

(Evaluation of Powder E)

At this stage, various evaluations of the obtained powder E were performed.

(Evaluation of Coercivity)

The coercivity of the powder E was measured using the following method.

First, the powder E and a thermoplastic resin were mixed and then magnetized in a magnetic field of 20 kOe to prepare a sample for powder coercivity measurement. Next, the sample for powder coercivity measurement was measured with VSM (Vibrating Sample Magnetometer). The measurement temperature was 27° C., and the maximum applied magnetic field was 90 kOe.

As a result of the measurement, the coercivity of the sample for powder coercivity measurement was 32.2 kOe.

(Measurement of Average Particle Diameter)

The powder E was mixed with a thermosetting epoxy resin, thermally cured, and then irradiated with FIB (Focused Ion Beam) to perform etching, thereby exposing a cross section and preparing a sample.

FE-SEM was used to observe the cross-sections of the samples and contour more than 200 randomly selected particles.

The contour lines correspond to the surfaces of the particles and/or the surfaces of the particles in contact. However, the particles in contact can be distinguished by FE-SEM backscattered electron image or by EDS mapping.

The diameter of a circle having the same area as the area surrounded by the contour line is defined as a particle diameter of the particle. The average particle diameter of the powder E was determined by calculating a volume-weighted average of the particle diameters of the particles.

The average particle diameter of the powder E was 1.4 μm.

(Preparation of Mixed Powder)

Next, the powder E (i.e., the Sm—Fe—N magnet powder) and Zn powder were slowly mixed by a V type blender to prepare a mixed powder.

The amount of Zn powder added was 10 wt % with respect to the entirety of the mixed powder. The average particle diameter of the Zn powder was 6 μm to 9 μm.

The prepared mixed powder is referred to as “mixed powder 1”.

(Preparation of Magnet)

Next, according to the following method, the mixed powder 1 was molded, and the obtained molded body was sintered to produce a magnet.

The molding pressure was 200 MPa.

The pressure of the molded body during the sintering process was 1200 MPa. The application of the pressure was started from room temperature. The sintering temperature of the molded body was 470° C., and the sintering time was 5 minutes.

Thus, a sintered magnet was obtained. The obtained sintered magnet is referred to as a “magnet 1”.

### Example 2

A sintered magnet was produced by substantially the same method as the method of the Example 1. However, in the Example 2, the application of the pressure in the sintering process was started when the temperature of the molded body reached 470° C. Other production conditions are the same as production conditions of the Example 1.

The obtained sintered magnet is referred to as a “magnet 2”.

### Example 3

A sintered magnet was produced by substantially the same method as the method of the Example 2. However, in the Example 3, the amount of Zn powder added in the mixed powder was 5 wt %. Other production conditions are the same as production conditions of the Example 2.

The obtained sintered magnet is referred to as a “magnet 3”.

### Example 4

A sintered magnet was produced by substantially the same method as the method of the Example 2. However, in the

Example 4, the amount of Zn powder added in the mixed powder was 20 wt %. Other production conditions are the same as production conditions of the Example 2.

The obtained sintered magnet is referred to as a “magnet 4”.

### Example 11

A sintered magnet was produced by substantially the same method as the method of the Example 1. However, in the Example 11, Zn powder was not added to the powder E, i.e., the powder E was molded and sintered to produce a magnet, without Zn powder.

The obtained sintered magnet is referred to as a “magnet 11”.

### Example 12

A sintered magnet was produced by substantially the same method as the method of the Example 2. However, in the Example 12, when preparing the mixed powder, the powder E and Zn powder were dispersed and mixed using a ball mill. Other production conditions are the same as production conditions of the Example 2.

The obtained sintered magnet is referred to as a “magnet 12”.

Table 1 below summarizes the production conditions of the magnets.

TABLE 1

| | | | | | | | | Pressure |
|---|---|---|---|---|---|---|---|---|
| | Coercivity | Zn powder | | | | | | application |
| | of powder | | Average particle | Amount | Molding | Sintering | Sintering | start |
| | E | | diameter | added | pressure | pressure | temperature | temperature |
| Magnet | (kOe) | Mixing method | (μm) | (wt %) | (MPa) | (MPa) | (° C.) | (° C.) |
| 1 | 32.2 | V type blender | 6~9 | 10 | 200 | 1200 | 470 | RT |
| 2 | 32.2 | V type blender | 6~9 | 10 | 200 | 1200 | 470 | 470 |
| 3 | 32.2 | V type blender | 6~9 | 5 | 200 | 1200 | 470 | 470 |
| 4 | 32.2 | V type blender | 6~9 | 20 | 200 | 1200 | 470 | 470 |
| 11 | 32.2 | — | — | — | 200 | 1200 | 470 | RT |
| 12 | 32.2 | Dispersion by | 6~9 | 10 | 200 | 1200 | 470 | 470 |
| | | bell milling | | | | | | |

(Evaluation)

The following evaluation was performed with respect to each produced magnet.

(Shape Evaluation of Sm—Fe—N System Particles)

The average particle diameter of the Sm—Fe—N particles contained in each magnet was measured. The aspect ratio of the Sm—Fe—N particles was also evaluated.

The average particle diameter of the Sm—Fe—N particles was measured by substantially the same method as the method for measuring the average particle diameter of the powder E explained above except that a sample is prepared by etching a cut magnet with irradiation of FIB so that a cross section is exposed.

Furthermore, the aspect ratio was evaluated as follows.

For each particle, a quadrilateral circumscribing the contour and minimizing the area was determined. The aspect ratio of each particle was calculated by dividing the length of the long side by the length of the short side of the obtained quadrilateral. Furthermore, the ratio of particles of which the aspect ratios are 2 or more was determined.

(Evaluation of Inter-Particle Metal Phase)

With respect to each magnet, an inter-particle metal phase formed between Sm—Fe—N particles was evaluated.

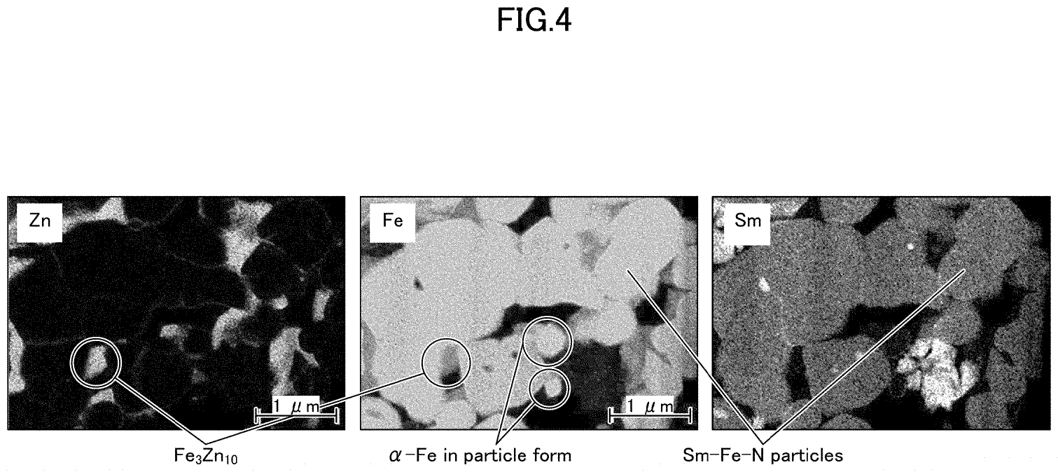

FIG. 4 is an EDS mapping image of Zn, Fe, and Sm in a cross section of the magnet 2.

It can be understood from FIG. 4 that the inter-particle metal phase has an area containing both Zn and Fe but not containing any Sm. It can also be understood that an Fe component in a particle form is dispersed in the inter-particle metal phase.

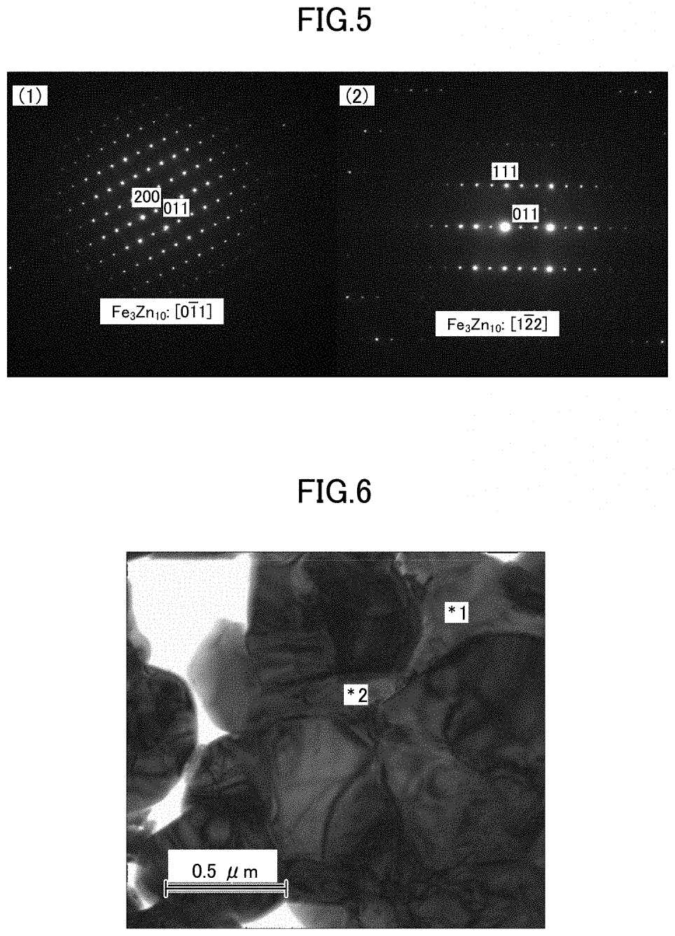

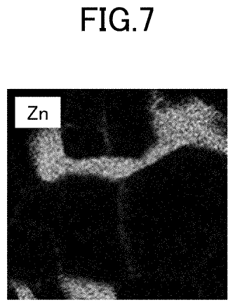

FIG. 5 is a drawing illustrating an electron diffraction image of an inter-particle metal phase in a cross section of the magnet 2. Furthermore, FIG. 6 is a cross-sectional TEM image of the analysis portion. FIG. 7 is an EDS mapping image of Zn in an area indicated in FIG. 6.

The portions indicated by marks “*1” and “*2” in FIG. 6 correspond to diffraction images “(1)” and “(2)” in FIG. 5, respectively. Further, it can be understood from the comparison between FIGS. 7 and 6 that the portions indicated by the marks “*1” and “*2” in FIG. 6 are both Zn-rich areas in the inter-particle metal phase.

The Zn-rich area in the inter-particle metal phase illustrated in FIG. 4 is composed of Fe₃Zn₁₀ phase as can be understood from FIGS. 5, 6, and 7.

In the inter-particle metal phase, the area ratios of the Fe₃Zn₁₀ phase and the α-Fe phase in the particle form are evaluated by image analysis. As described above, the area ratio is determined by averaging area ratios derived from 20 cross-sectional photos, the field of view of each of which includes 20 or more Sm—Fe—N particles.

(Evaluation of the Surface of the Sm—Fe—N Particle)

20 Sm—Fe—N particles were selected, and the thickness of the coating layer (Sm—Fe—Zn phase) famed on the surface of each particle was measured. The average thickness of the coating layer was derived by averaging these measured results.

Furthermore, the amount of Zn included in the coating layer was derived by EDS from the 20 Sm—Fe—N particles selected. The average value of the amount of Zn included in the coating layer was derived by averaging these measured results.

(Measurement of the Amount of Zn in Magnet)

The amount of Zn contained in the entirety of the magnet was evaluated by ICP-AES (Inductively Coupled Plasma Atomic Emission Spectroscopy).

(Measurement of the Amount of Residual Oxygen in Magnet)

With respect to each magnet, the amount of residual oxygen was determined by inert gas fusion-nondispersive infrared absorption.

(Evaluation of Coercivity and Residual Magnetic Flux Density)

The coercivity of the magnet was measured with VSM. The measurement temperature was 27° C., and the maximum applied magnetic field was 90 kOe.

Furthermore, the residual magnetic flux density of each magnet was measured by using the same apparatus.

Table 2 below summarizes the evaluation results of the magnets.

TABLE 2

| | | | Inter-particle | | | | | | | |
|---|---|---|---|---|---|---|---|---|---|---|
| | Sm—Fe—N particle | | metal phase | | | | | | | |
| | | Ratio of | | Area of | | | | | | Residual |
| | Average | particles of | | α-Fe in | Coating layer | | | Oxygen | | magnetic |
| | particle | which aspect | Area of | particle | Average | Average | Zn content | content | | flux |
| | diameter | ratios are 2.0 | Fe₃Zn₁₀ | form | Zn content | thickness | in magnet | in magnet | Coercivity | density |
| Magnet | (μm) | or more (%) | (%) | (%) | (at %) | (nm) | (wt %) | (wt %) | (kOe) | (kG) |
| 1 | 1.6 | 8.0 | 89 | 6 | 10.6 | 35 | 10 | 0.7 | 22.2 | 5.8 |
| 2 | 1.5 | 6.0 | 93 | 6 | 10.2 | 36 | 10 | 0.7 | 24.6 | 5.4 |
| 3 | 1.5 | 7.0 | 88 | 9 | 4.8 | 38 | 5 | 0.7 | 20.5 | 5.3 |
| 4 | 1.5 | 6.0 | 82 | 5 | 16.5 | 38 | 20 | 0.7 | 26.3 | 4.8 |
| 11 | 1.4 | 8.0 | 0 | 0 | — | — | 0 | 0.7 | 12.8 | 4.5 |
| 12 | 1.2 | 14.0 | 55 | 7 | 21.0 | 39 | 10 | 0.8 | 19.1 | 5.0 |

As shown in Table 2, it can be understood that the inter-particle metal phase is famed in any of the magnets 1 to 3, and the inter-particle metal phase includes the Fe₃Zn₁₀ phase and the α-Fe phase in the particle form. In any of the magnets 1 to 4, the area ratio of the Fe₃Zn₁₀ phase in the inter-particle metal phase was 82% or more, and in any of the magnets 1 to 4, the area ratio of the α-Fe phase in the particle form was 9% or less.

In the magnet 12, the inter-particle metal phase was also formed, but the area ratio of the Fe₃Zn₁₀ phase included in the inter-particle metal phase was 55%.

In the magnet 11 and the magnet 12, the coercivity was at most 19.1 kOe, which was much lower than the coercivity of the powder E of 32.2 kOe.

In contrast, in the magnets 1 to 4, the coercivity was 20.5 kOe or more, and it was understood that a reduction in the coercivity was significantly alleviated. In any the magnets 1 to 4, the residual magnetic flux density was 4.8 kG or more, and it was confirmed that a magnet that has a relatively high density was formed.

According to the present disclosure, a Sm—Fe—N magnet that has a high density and that significantly alleviates a reduction in the coercivity as compared with the coercivity of Sm—Fe—N powder can be provided.

The preferred embodiment of the present disclosure has been described above in detail. However, the present disclosure is not limited to the embodiment described above. Various modifications and substitutions can be applied to the above-described embodiment without departing from the scope of the present disclosure. Each of the features described with reference to the above-described embodiment may be appropriately combined unless such combination is technically contradictory.

What is claimed is:

1. A Sm—Fe—N magnet comprising:
Sm—Fe—N particles,
wherein an inter-particle metal phase is present between at least two of the Sm—Fe—N particles,
an average particle diameter of the Sm—Fe—N particles is less than 2.0 μm, and a percentage of the Sm—Fe—N particles having an aspect ratio of 2.0 or more is 10% or less,
the inter-particle metal phase includes: a Fe₃Zn₁₀ phase; and an α-Fe phase in a particle form, and
in the inter-particle metal phase, an area ratio of the Fe₃Zn₁₀ phase is 80% or more.

2. The Sm—Fe—N magnet according to claim 1, wherein in the inter-particle metal phase, an area ratio of the α-Fe phase in a particle form is 10% or less.

3. The Sm—Fe—N magnet according to claim 1, wherein each of the Sm—Fe—N particles has a surface,
a Sm—Fe—Zn coating layer is formed in at least a portion of the surface, and
the Sm—Fe—Zn coating layer includes Zn at 1 at % or more and 20 at % or less.

4. The Sm—Fe—N magnet according to claim 3, wherein the Sm—Fe—Zn coating layer has an average thickness of 1 nm or more and 100 nm or less.

5. The Sm—Fe—N magnet according to claim 1, wherein the Sm—Fe—N magnet includes Zn at 1 wt % or more and 20 wt % or less.

6. The Sm—Fe—N magnet according to claim 1, wherein the Sm—Fe—N magnet includes oxygen at less than 1.0 wt %.
